(19) United States
(12) Patent Application Publication
(10) Pub. No.: US 2009/0302002 A1
(43) Pub. Date: Dec. 10, 2009

(54) METHOD AND APPARATUS FOR REMOVING POLYMER FROM A SUBSTRATE

(75) Inventors: Kenneth Collins, San Jose, CA (US); Martin Salinas, San Jose, CA (US); Walter Merry, Sunnyvale, CA (US); Jie Yuan, San Jose, CA (US); Andrew Nguyen, San Jose, CA (US); Kartik Ramaswamy, San Jose, CA (US); Jennifer Sun, Mountain View, CA (US); Ren-Guan Duan, San Jose, CA (US); Xiaoming He, Arcadia, CA (US); Nancy Fung, Livermore, CA (US)

Correspondence Address: PATTERSON & SHERIDAN, LLP - - APPM/TX, 3040 POST OAK BOULEVARD, SUITE 1500, HOUSTON, TX, 77056, US

(73) Assignee: APPLIED MATERIALS, INC., Santa Clara, CA (US)

(21) Appl. No.: 12/395,057

(22) Filed: Feb. 27, 2009

Related U.S. Application Data
(60) Provisional application No. 61/032,699, filed on Feb. 29, 2008.

(51) Int. Cl. B44C 1/22; C23F 1/08

(52) U.S. Cl. 216/67; 156/345.35

(57) ABSTRACT

A method and an apparatus for removing polymer from a substrate are provided. In one embodiment, an apparatus utilized to remove polymer from a substrate includes a processing chamber having a chamber wall and a chamber lid defining a process volume, a substrate support assembly disposed in the processing chamber, and a remote plasma source coupled to the processing chamber through an outlet port formed within the chamber wall, the outlet port having an opening pointing toward an periphery region of a substrate disposed on the substrate support assembly, wherein the remote plasma source is fabricated from a material resistant to hydrogen species.

### CROSS-REFERENCE TO RELATED APPLICATION

This application claims benefit of U.S. Provisional Application Ser. No. 61/032,699 filed Feb. 29, 2008 (Attorney Docket No. APPM/13209L), which is incorporated by reference in its entirety.

### BACKGROUND

1. Field

Embodiments of the present invention generally relate to a semiconductor processing systems. More specifically, embodiments of the invention relates to a semiconductor processing system utilized to remove polymers from a backside of a substrate in semiconductor fabrication.

2. Description of the Related Art

Integrated circuits have evolved into complex devices that can include millions of components (e.g., transistors, capacitors and resistors) on a single chip. The evolution of chip designs continually requires faster circuitry and greater circuit density. The demands for greater circuit density necessitate a reduction in the dimensions of the integrated circuit components.

As the dimensions of the integrated circuit components are reduced (e.g. to sub-micron dimensions), the importance of reducing presence of contaminant has increased since such contaminant may lead to the formation of defects during the semiconductor fabrication process. For example, in an etching process, by-products, e.g., polymers that may be generated during the etching process, may become a source of particulate, contaminating integrated circuits and structures formed on the substrate.

In order to maintain high manufacturing yield and low costs, the removal of contaminant and/or residual polymer from the substrate becomes increasingly important. Residual polymer present on the substrate bevel may be dislodged and adhered to the front side of the substrate, potentially damaging integrated circuits formed on the front side of the substrate. In the embodiment wherein residual polymer present on the substrate bevel are dislodged and adhered to a backside of a substrate, non-planarity of the substrate during a lithographic exposure process may result in lithographic depth of focus errors. Furthermore, residual polymer present on the backside of the substrate may also be dislodged and flaked off during robot transfer process, substrate transport process, subsequent manufacturing processes, and so on, thereby resulting in contamination in transfer chambers, substrate cassettes, process chambers and other processing equipment that may be subsequently utilized in the circuit component manufacturing process. Contamination of processing equipment results in increased tool down time, thereby adversely increasing the overall manufacturing cost.

In conventional polymer removal processes, a scrubber clean is often utilized to remove polymers from substrate bevel and backside. However, during the cleaning process, structures formed in the front side of the substrate may also be damaged, resulting in product yield loss and device failure.

During etching, a photoresist layer is typically utilized as an etch mask layer that assists transferring features to the substrate. However, incomplete removal of the photoresist layer on the front side of the substrate may also contaminant the structures formed on the substrate, resulting in product yield loss and device failure.

Therefore, there is a need for an apparatus and method to remove polymer from substrate bevel backside while maintaining integrity of structures formed on substrate front side.

### SUMMARY

Embodiments of the invention include a method and an apparatus for removing polymer from a substrate are provided. In one embodiment, an apparatus utilized to remove polymer from a substrate includes a polymer removal chamber having a chamber wall and a chamber lid defining a process volume, a substrate support assembly disposed in the polymer removal chamber, and a remote plasma source coupled to the polymer removal chamber through an outlet port formed within the chamber, the outlet port having an opening pointing toward an periphery region of a substrate disposed on the substrate support assembly, wherein the remote plasma source is fabricated from a material resistant to hydrogen species.

In another embodiment, a substrate processing system utilized to removal polymer from a substrate includes at least one etch reactor disposed to a semiconductor system, a polymer removal polymer removal chamber disposed to the semiconductor system, and a remote plasma source coupled to the polymer removal polymer removal chamber through an outlet port formed in the polymer removal polymer removal chamber, the outlet port having an opening pointing inward from a wall of the polymer removal chamber, wherein the remote plasma source is fabricated from a hydrogen resistant material.

In yet another embodiment, a method for removing polymer from a substrate includes etching a material layer disposed on a substrate in an etch reactor, transferring the etched substrate to polymer removal polymer removal chamber, supplying an inert gas to a front side of the substrate through a center region disposed in the polymer removal chamber, supplying a hydrogen containing gas through a remote plasma source coupled to the polymer removal chamber to an periphery region of the substrate, wherein a surface exposed to plasma within the remote plasma source is fabricated from a material resistant to reductive deterioration by hydrogen species.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings.

FIG. 1 is a schematic cross sectional diagram of an exemplary polymer removal chamber comprising a remote plasma source (RPS) in accordance with one embodiment of the invention;

FIG. 2 is a schematic cross sectional diagram of another exemplary polymer removal chamber comprising a remote toroidal plasma source;

FIG. 3 one embodiment of an exemplary substrate etching apparatus;

FIG. 4 is a semiconductor processing system including a polymer removal chamber; and

FIG. 5 is a diagram of one embodiment of a process flow utilizing the semiconductor processing system of FIG. 4.

It is to be noted, however, that the appended drawings illustrate only typical embodiments of this invention and are therefore not to be considered limiting of its scope, for the invention may admit to other equally effective embodiments.

To facilitate understanding, identical reference numerals have been used, where possible, to designate identical elements that are common to the figures.

### DETAILED DESCRIPTION

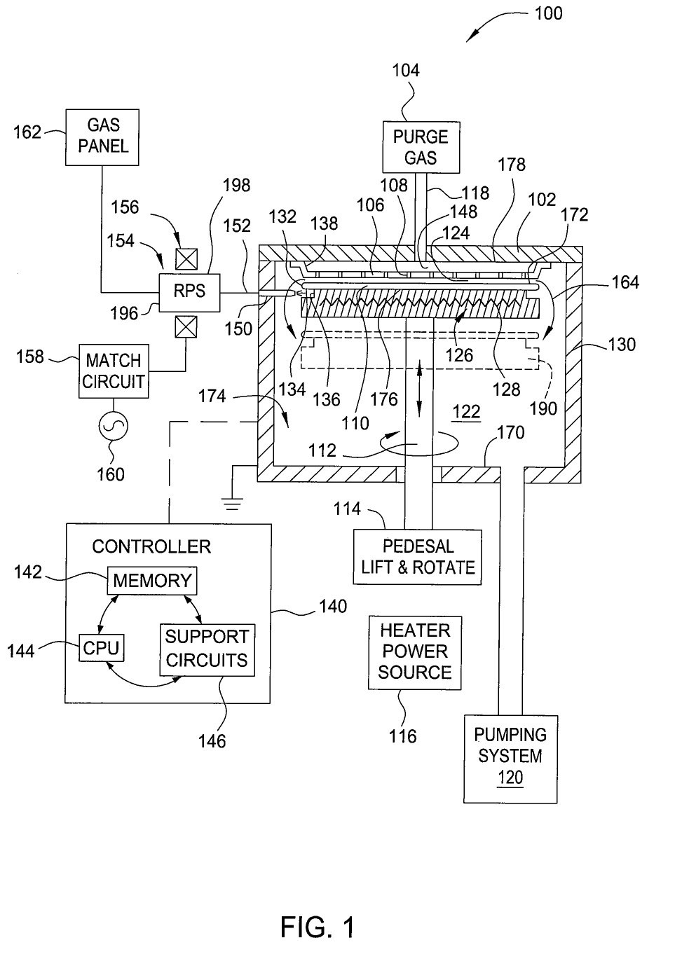

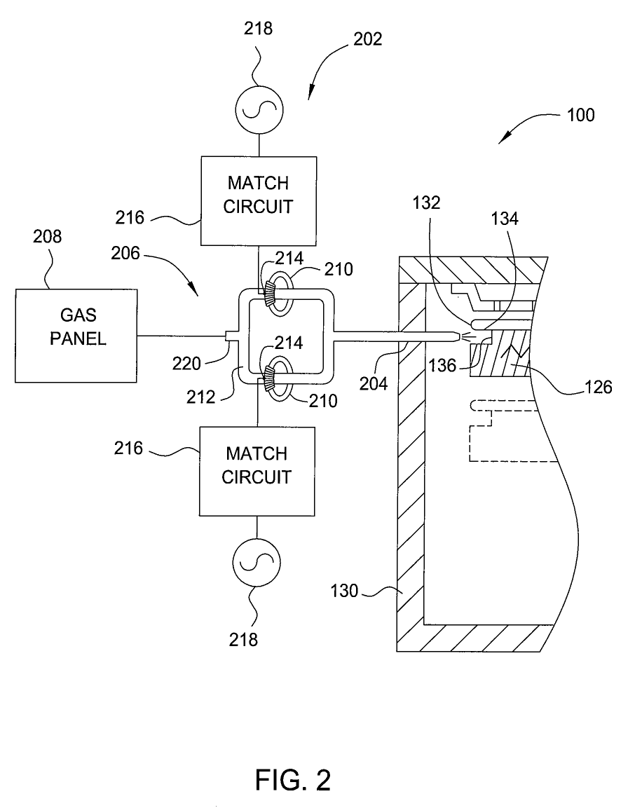

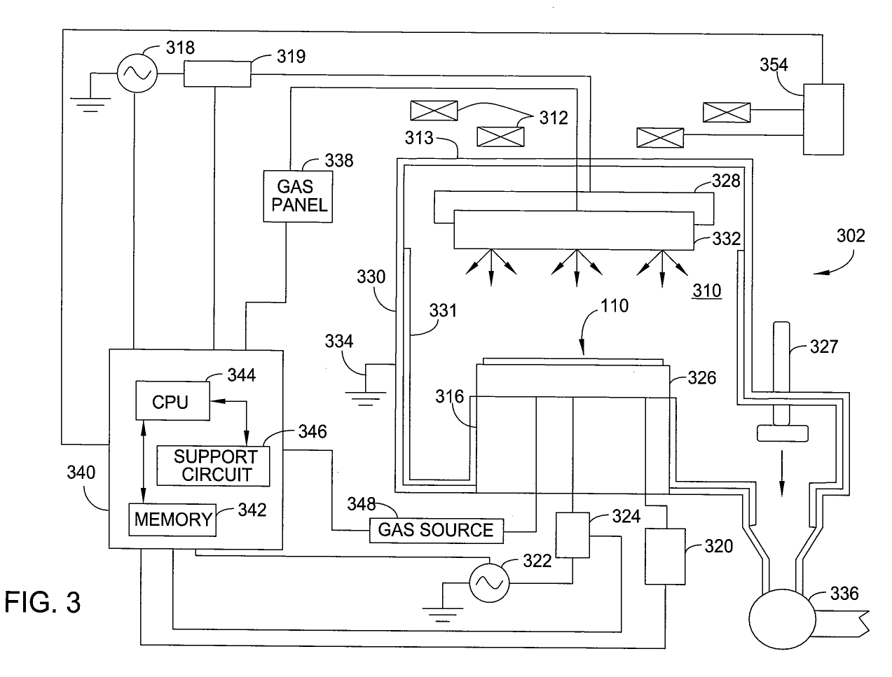

Embodiments of the present invention include methods and apparatuses that may be utilized to remove polymers from a substrate periphery region, such as an edge or bevel of the substrate. The substrate bevel, backside and substrate periphery region may be efficiently cleaned. In the embodiment wherein a photoresist layer, if any, is present on front side of the substrate, the photoresist layer may be moved as well. In one embodiment, a polymer removal apparatus includes a plasma source fabricated from a hydrogen resistant material. The polymer removal apparatus is generally used to remove polymers from a substrate generated during a semiconductor substrate process, such as an etching or deposition process, among others. One exemplary polymer removal apparatus described herein, with referenced to FIGS. 1-2, is a polymer removal chamber. One exemplary substrate processing apparatus (e.g., etch reactor) described herein, with referenced to FIG. 3, is an ENABLER® processing chamber, available from Applied Materials, Inc. of Santa Clara, Calif., It is contemplated that embodiments of the polymer removal chamber described herein may be performed in other processing chambers, including those available from other manufacturers.

FIG. 1 depicts a sectional schematic diagram of an exemplary polymer removal processing chamber 100 having a plasma source 154 utilized to remove polymer from the edge or bevel of a substrate 110. A controller 140 including a central processing unit (CPU) 144, a memory 142, and support circuits 146 is coupled to the processing chamber 100. The controller 140 controls components of the processing chamber 100, processes performed in the processing chamber 100, as well as may facilitate an optional data exchange with databases of an integrated circuit fab.

The processing chamber 100 includes a chamber lid 102, a bottom 170 and side walls 130 that enclose an interior volume 174. The chamber lid 102 has a bottom surface defining a ceiling 178 of the processing chamber 100. In the depicted embodiment, the chamber lid 120 is a substantially flat dielectric member. Other embodiments of the processing chamber 100 may have other types of lids, e.g., a dome-shaped ceiling and/or metallic construction.

A substrate support assembly 126 is disposed in the processing chamber 100 dividing the interior volume 174 into an upper zone 124 and a lower zone 122. The substrate support assembly 126 has an upper surface 176 utilized to receive a substrate 110 disposed thereon. In one embodiment, the substrate support assembly 126 has a step 136 formed in an upper periphery region of the substrate support assembly 126. The step 136 has a width selected to reduce a diameter of the upper surface 176 of the substrate support assembly 126. The diameter of the upper surface 176 of the substrate support assembly 126 is selected so that an edge 132 and a backside periphery 134 of the substrate 110 are exposed when the substrate is disposed on the substrate support assembly 126.

A heating element 128 is within the substrate support assembly 126 to facilitate temperature control of the substrate 110 disposed on the substrate support assembly 126. The heating element 128 is controlled by a power source 116 coupled to the substrate support assembly 126 through a slip ring, not shown. A rotatable shaft 112 extends upward through the bottom 170 of the processing chamber 100 and is coupled to the substrate support assembly 126. A lift and rotation mechanism 114 is coupled to the shaft 112 to control rotation and elevation of the substrate support assembly 126 relative to the chamber ceiling 178. A pumping system 120 is coupled to the processing chamber 100 to facilitate evacuation and maintenance of process pressure.

A purge gas source 104 is coupled to the chamber lid 102 through a gas supply conduit 118. The purge gas source 104 supplies purge gas to the processing chamber 100. A gas distribution plate 106 is coupled to the chamber ceiling 178 and has a plurality of apertures 108 formed therein. An internal plenum 148 is defined between the gas distribution plate 106 and the chamber ceiling 178 that facilitates communication of purge gases supplied from the purge gas source 104 to the plurality of apertures 108. The purge gases exit the apertures 108 and travel through the upper zone 124 of the processing chamber 100 so as to blanket a front side 172 of the substrate 110. In one embodiment, the purge gas is selected to be non-reactive to the materials disposed on the front side 172 of the substrate. The non-reactive purge gas flows toward the substrate surface 172 assists purging the front side 172 of the substrate 110 without adversely impacting or damaging structures and/or devices formed thereon. The non-reactive purge gas prevents the structures formed on the front side 172 of the substrate 100 from reacting with the chemical species or molecular left on the gas distribution plate 106 and/or ceiling 178. In one embodiment, the purge gas supplied from the purge gas source 104 may include at least one of CO, CO₂, NH₃, or an inert gas, such as N₂, Ar or He, among others.

A remote plasma source 154 is coupled to a gas outlet port 150 formed through a sidewall 130 of the processing chamber. In the embodiment depicted in FIG. 1, the remote plasma source 154 is remotely coupled to the processing chamber 100. The gas outlet port 150 may include a nozzle extending into the processing volume 174 to precisely direct the gas flow exiting the nozzle. The gas outlet port 150 is fabricated from or coated with a material resistant to reductive deterioration by hydrogen species.

The remote plasma source 154 includes a remote plasma chamber 198 having an internal volume 196 coupling a gas panel 162 to the gas outlet 150. One or more inductive coil elements 156 disposed adjacent to the remote plasma chamber 198 are coupled, through a matching network 158, to a radio frequency (RF) plasma power source 160 to generate and/or maintain plasma in the volume 196 formed from gases provided by the gas panel 162. The gas panel 162 is reactive gases. In one embodiment, the gas panel 162 provides H₂. In another embodiment, the gas panel 162 provides H₂ and H₂O. In yet another embodiment, the gas panel 162 provides N₂, H₂ and NH₃. In still another embodiment, the gas panel 162 provides at least one of O₂, H₂O, NH₃, N₂, and H₂. The gases supplied to the remote plasma chamber 198 are dissociated as neutrals and radicals by plasma generated in the interior volume 196. The dissociated neutral and radicals are further directed through the outlet port 150 to the processing chamber. The elevation of substrate support assembly 126 may be selected to position the gas outlet port 150 above, below or aligned with the substrate bevel 132 to selectively clean the top, bottom and/or edge of the substrate 110. Outflow of the dissociated neutral and radicals from the outlet port 150 may be directed toward the step 136, as the substrate is rotated, thereby filling a cavity defined between the substrate backside 134 and the substrate support assembly 126. The cavity assists retaining gases so that the substrate bevel 132 and the substrate backside 134 are exposed to the reactive gases for a longer period of time, thereby improving the polymer removal efficiency. Optionally, the substrate support assembly 126 may be positioned in a lower position (shown in phantom) so that the gas outflow from the outlet port 150 may be directed to an exposed edge on front side 172 of the substrate 110, thereby assisting removing polymers, or remaining photoresist layer, if any, from the front side 172 of the substrate 110.

In one embodiment, the materials utilized to fabricate or coat the interior volume 196 of the remote plasma chamber 198 are selected from a material resistant to plasma generated from a hydrogen-containing gas. Some hydrogen containing gases dissociated in the interior volume 196 may include H₂ and water (H₂O) vapor, among others. Conventional oxide surfaces of remote plasma sources exhibit chemical reactivity to hydrogen species, deteriorating surfaces of the remote plasma chamber 198. Thus, the walls of the interior volume 196 are comprised of a material immune to this reductive deterioration. The materials for fabricating or coating the interior volume 196 are selected to have a high resistivity or substantially non-reactive to plasma dissociated species. In one embodiment, the materials includes metallic material, such as aluminum (Al), aluminum alloy, titanium (Ti), titanium alloy, palladium (Pd), palladium alloy, zirconium (Zr), zirconium alloy, hafnium (Hf), or hafnium alloy, ceramic material, rare earth containing materials, such as niobium (Nb), niobium alloy, yttrium (Y), or yttrium alloy, and the like. Particularly, gold, copper and iron alloys should be avoided. Suitable examples of the materials suitable for fabricating or coating interior volume 196 includes bare aluminum or aluminum alloy, titanium, titanium alloy (e.g., Ti with 45 molecular percentage of Niobium (Nb)), aluminum and yttrium alloy, (e.g., 13 molecular percentage of Al with 87 molecular percentage of Y), yttrium aluminum garnet (YAG, Y₃Al₅O₁₂), YZZO (about 73.2 molecular percentage of Y₂O₃ with about 26.8 molecular percentage of ZrO₂), YA3070 (about 8.5 molecular percentage of Y₂O₃ with about 91.5 molecular percentage of Al₂O₃), HPM (about 63 molecular percentage of Y₂O₃ with about 14 molecular percentage of Al₂O₃ and further with about 23 molecular percentage of ZrO₂), NB01 (about 70 molecular percentage of Y₂O₃ with about 10 molecular percentage of Nb₂O₅ and further with about 20 molecular percentage of ZrO₂), NB04 (about 60 molecular percentage of Y₂O₃ with about 20 molecular percentage of Nb₂O₅ and further with about 20 molecular percentage of ZrO₂), HF01 (about 75 molecular percentage of Y₂O₃ with about 20 molecular percentage of HfO₂ and further with about 5 molecular percentage of ZrO₂) and Y—Zr02 (about 3 molecular percentage of Y₂O₃ with about 97 molecular percentage of ZrO₂), combinations thereof, and the like. In one embodiment, the remote plasma source 154 may be fabricated from a plastic coated with the above-reference materials. The plastic has certain rigidity and physical properties sufficient to confine plasma in the remote plasma chamber 198.

In operation, the purge gas from the purge gas source 104 as well as the reacting gas from the plasma source 154 is simultaneously supplied to both the front side 172, and periphery region of the substrate 110 to remove polymers, and/or remaining photoresist layer, if any, from the substrate 110. Alternatively, the gases from the purge source 104 and/or plasma source 154 may be pulsed into the processing chamber 100. During processing, the substrate support assembly 126 may be moved in a vertical direction, rotated, or orientated to position the substrate 110 between the upper zone 124 and lower zone 122 so that gases are delivered from the outlet 150 to a desired region of the substrate 110. The rotation of the substrate 110 assists gases from the plasma source 154 to be applied uniformly to the substrate bevel 132 or other desired region of the substrate 110.

FIG. 2 depicts the processing chamber 100 having another embodiment of a plasma source 202 externally coupled to the processing chamber 100. The plasma source 202 has a toroidal plasma applicator 206 having at least one magnetically permeable core 210 wrapped around a section of a toroidal plasma chamber 212. A coil 214 is wrapped around the magnetically permeable cores 210 and connected to a radio-frequency (RF) plasma power source 218 through a matching network 216. Power applied to the coil 214 maintains a plasma formed from gases in the toroidal plasma applicator 206.

The toroidal plasma chamber 212 has an inlet port 220 and an outlet port 204. The inlet port 220 is coupled to a gas panel 208 configured to supply reactive gas to the plasma chamber 212. As the reactive gas is dissociated in the plasma chamber 212, the dissociated neutrals, radicals and/or reactive ion species are supplied through the outlet port 204 to the processing chamber 100. The outflow from the outlet port 204 is directed in substantial horizontal inward direction, as discussed above with reference to FIG. 1. Similar to the design of FIG. 1, the elevation of the substrate support assembly 126 may be selected so the outflow from the outlet port 204 may be directed to the bevel 132, backside 134 and/or front side 172 of the substrate 110.

In one embodiment, the toroidal plasma chamber 212 may be fabricated from a hydrogen plasma resistant material similar to the materials selected for the remote plasma chamber 198 of FIG. 1. As plasma is dissociated, the interior surface of the toroidal plasma chamber 202 may be exposed to and in contact with the aggressive reactive species including halogen containing radicals, hydrogen radicals, oxygen radicals, hydroxyl radical (—OH), nitrogen radical, N—H radical, or water (H₂O) vapor, and some other similar corrosive reactive species. Accordingly, the materials selected to fabricate the toroidal plasma chamber 202 has a high resistivity and is non-reactive to these plasma dissociated reactive species, such as the materials selected to fabricate the remote plasma chamber 198.

FIG. 3 depicts a schematic, cross-sectional diagram of one embodiment of a plasma etch reactor 302 suitable for performing an etch process that produces polymer residues, such as an oxide or SiC etch process. One such plasma etch reactor suitable for performing the invention is the ENABLER® processing chamber. It is contemplated that the substrate 110 may be processed in other etch reactors, including those from other equipment manufacturers.

In one embodiment, the reactor 302 includes a process chamber 310. The process chamber 310 is a high vacuum vessel that is coupled through a throttle valve 327 to a vacuum pump 336. The process chamber 310 includes a conductive chamber wall 330. The temperature of the chamber wall 330 is controlled using liquid-containing conduits (not shown) that are located in and/or around the wall 330. The chamber wall 330 is connected to an electrical ground 334. A liner 331 is disposed in the chamber 310 to cover the interior surfaces of the walls 330.

The process chamber 310 also includes a support pedestal 316 and a gas distributor. The gas distributor may be one or more nozzles disposed in the ceiling or walls of the chamber, or a showerhead 332, as shown in FIG. 3. The support pedestal 316 is disposed below the showerhead 332 in a spaced-apart relation. The support pedestal 316 may include an electrostatic chuck 326 for retaining the substrate 110 during processing. Power to the electrostatic chuck 326 is controlled by a DC power supply 320.

The support pedestal 316 is coupled to a radio frequency (RF) bias power source 322 through a matching network 324. The bias power source 322 is generally capable of producing an RF signal having a tunable frequency of from about 50 kHz to about 60 MHz and a bias power of about 0 to 5,000 Watts. Optionally, the bias power source 322 may be a DC or pulsed DC source.

The temperature of the substrate 110 supported on the support pedestal 316 is at least partially controlled by regulating the temperature of the support pedestal 316. In one embodiment, the support pedestal 316 includes a channels formed therein for flowing a coolant. In addition, a backside gas, such as helium (He) gas, provided from a gas source 348, fits provided into channels disposed between the back side of the substrate 110 and grooves (not shown) formed in the surface of the electrostatic chuck 326. The backside He gas provides efficient heat transfer between the pedestal 316 and the substrate 110. The electrostatic chuck 326 may also include a resistive heater (not shown) within the chuck body to heat the chuck 326 during processing.

The showerhead 332 is mounted to a lid 313 of the processing chamber 310. A gas panel 338 is fluidly coupled to a plenum (not shown) defined between the showerhead 332 and the lid 313. The showerhead 332 includes a plurality of holes to allow gases provided to the plenum from the gas panel 338 to enter the process chamber 310. The holes in the showerhead 332 may be arranged in different zones such that various gases can be released into the chamber 310 with different volumetric flow rates.

The showerhead 332 and/or an upper electrode 328 positioned proximate thereto is coupled to an RF source power 318 through an impedance transformer 319. The RF source power 318 is generally capable of producing an RF signal having a tunable frequency of about 160 MHz and a source power of about 0 to 5,000 Watts.

The reactor 302 may also include one or more magnets or coil segments 312 positioned exterior to the chamber wall 330, near the chamber lid 313. Power to the coil segment(s) 312 is controlled by a DC power source or a low-frequency AC power source 354.

During substrate processing, gas pressure within the interior of the chamber 310 is controlled using the gas panel 338 and the throttle valve 327. In one embodiment, the gas pressure within the interior of the chamber 310 is maintained at about 0.1 to 999 mTorr. The substrate 110 may be maintained at a temperature of between about 10 to about 500 degrees Celsius.

A controller 340, including a central processing unit (CPU) 344, a memory 342, and support circuits 346, is coupled to the various components of the reactor 302 to facilitate control of the processes of the present invention. The memory 342 can be any computer-readable medium, such as random access memory (RAM), read only memory (ROM), floppy disk, hard disk, or any other form of digital storage, local or remote to the reactor 302 or CPU 344. The support circuits 346 are coupled to the CPU 344 for supporting the CPU 344 in a conventional manner. These circuits include cache, power supplies, clock circuits, input/output circuitry and subsystems, and the like. A software routine or a series of program instructions stored in the memory 342, when executed by the CPU 344, causes the reactor 302 to perform an etch process of the present invention.

FIG. 3 only shows one exemplary configuration of various types of plasma reactors that can be used to practice the invention. For example, different types of source power and bias power can be coupled into the plasma chamber using different coupling mechanisms. Using both the source power and the bias power allows independent control of a plasma density and a bias voltage of the substrate with respect to the plasma. In some applications, the source power may not be needed and the plasma is maintained solely by the bias power. The plasma density can be enhanced by a magnetic field applied to the vacuum chamber using electromagnets driven with a low frequency (e.g., 0.1-0.5 Hertz) AC current source or a DC source. In other applications, the plasma may be generated in a different chamber from the one in which the substrate is located, e.g., remote plasma source, and the plasma subsequently guided into the chamber using techniques known in the art.

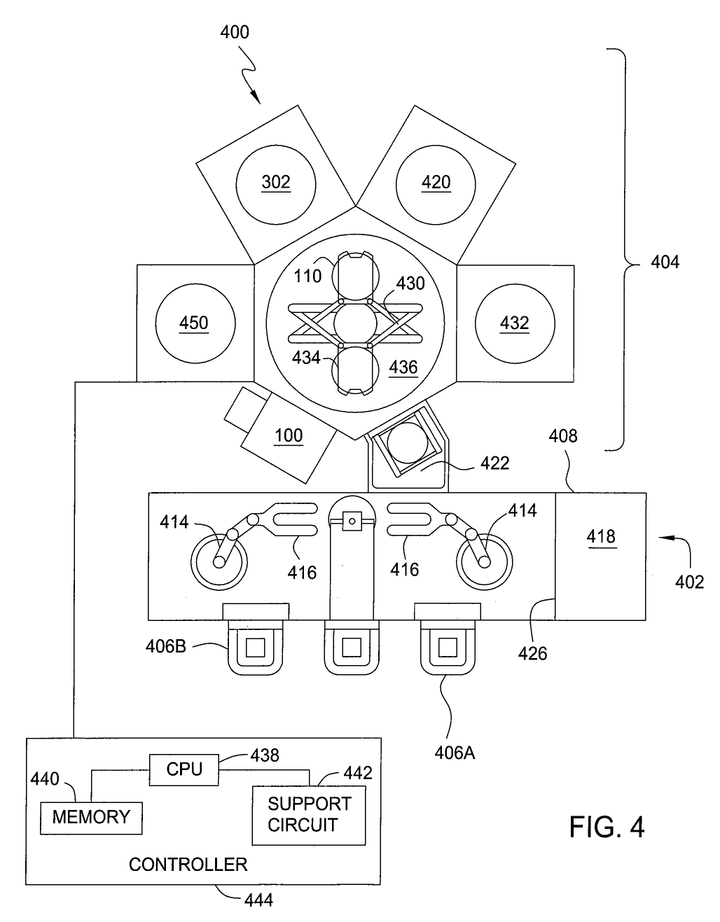

FIG. 4 is a schematic, top plan view of an exemplary processing system 400 that includes one embodiment of the polymer removal processing chamber 100 and substrate processing chamber 302 suitable for practicing the present invention. In one embodiment, the processing system 400 may be a CENTURA® integrated processing system, commercially available from Applied Materials, Inc., located in Santa Clara, Calif. It is contemplated that other processing systems (including those from other manufacturers) may be adapted to benefit from the invention.

The system 400 includes a vacuum-tight processing platform 404, a factory interface 402, and a system controller 444. The platform 404 includes a plurality of processing chambers 100, 302, 420, 432, 450 and at least one load-lock chamber 422 that are coupled to a vacuum substrate transfer chamber 436. One load lock chamber 422 is shown in FIG. 4. It should be noted that the polymer removal chamber 100 may be located in a position typically occupied by a load lock chamber on conventional systems, thus making incorporation into existing tools feasible without major modification or loss of a primary processing chamber. The factory interface 402 is coupled to the transfer chamber 436 by the load lock chamber 422. In one embodiment, the plurality of processing chambers include at least one polymer removal chamber as described above and one or more substrate processing reactors 302 of FIG. 3.

In one embodiment, the factory interface 402 comprises at least one docking station 408 and at least one factory interface robot 414 to facilitate transfer of substrates 110. The docking station 408 is configured to accept one or more front opening unified pod (FOUP). Two FOUPS 406A-B are shown in the embodiment of FIG. 4. The factory interface robot 414 having a blade 416 disposed on one end of the robot 414 is configured to transfer the substrate 110 from the factory interface 402 to the processing platform 404 for processing through the load lock chambers 422. Optionally, one or more metrology stations 418 may be connected to a terminal 426 of the factory interface 402 to facilitate measurement of the substrate from the FOUPS 406A-B.

The load lock chamber 422 has a first port coupled to the factory interface 402 and a second port coupled to the transfer chamber 436. The load lock chamber 422 is coupled to a pressure control system (not shown) which pumps down and vents the load lock chamber 422 to facilitate passing the substrate between the vacuum environment of the transfer chamber 436 and the substantially ambient (e.g., atmospheric) environment of the factory interface 402.

The transfer chamber 436 has a vacuum robot 430 disposed therein. The vacuum robot 430 has a blade 434 capable of transferring substrates 110 between the load lock chamber 422 and the processing chambers 100, 302, 420, 432, 450.

In one embodiment, the etch chamber 302 may use reactive gases, such as a halogen-containing gas, a carbon containing gas, a silicon fluorine gas, a nitrogen containing gas to etch the substrate 110 therein. Examples of reactive gas include carbon tetrafluoride (CF₄), C₄F₆, C₄F₈, CHF₃, C₂F₆, C₅F₈, CH₂F₂, SiF₄, SiCl₄, Br₂, NF₃, N₂, CO, CO₂, hydrogen bromide (HBr), chlorine (Cl₂) and the like. An inert gas, such as He or Ar, may also be supplied into the etch chamber. The material layers disposed on the substrate 110 that may be etched during the etching process include a low-k layer, a barrier layer, a silicon containing layer, a metal layer, and a dielectric layer. Examples of material layers to be etched includes silicon carbide oxide (SiOC), such as BLACK DIAMOND® film commercially available from Applied Materials, Inc., silicon carbide (SiC) or silicon carbide nitride (SiCN), such as BLOk® film commercially available from Applied Materials, Inc., CVD oxide, SiO₂, polysilicon, TEOS, amorphous silicon, USG, silicon nitride (SiN), boron doped or phosphorous doped silicon film, and the like. In an exemplary embodiment wherein the material layer disposed on the substrate 110 is a silicon carbide oxide layer (SiOC), a gas mixture including at least one of CF₄, C₄F₆, O₂ and Ar may be used to etch the silicon carbide oxide layer. CO, CO₂ may also be optionally supplied. In another exemplary embodiment wherein the material layer disposed on the substrate 110 is a silicon oxide layer (SiO₂), a gas mixture including at least one of C₄F₈, C₂F₆, C₄F₆, CF₄ and CHF₃ may be used to etch the silicon oxide layer. In yet another embodiment wherein the material layer disposed on the substrate 110 is a silicon carbide (SiC) and/or a silicon carbide nitride layer (SiCN), the gas mixture including at least one of CH₂F₂, N₂ and Ar may be used to etch the silicon carbide (SiC) and/or silicon carbide nitride layer (SiCN). In still another embodiment wherein the material layer disposed on the substrate 110 is a silicon nitride (SiN), the gas mixture including at least one of CH₂F₂, CHF₃, N₂ and Ar may be used to etch the silicon nitride layer (SiN).

The system controller 444 is coupled to the processing system 400. The system controller 444 controls the operation of the system 400 using a direct control of the process chambers 100, 302, 420, 432, 450 of the system 400 or alternatively, by controlling the computers (or controllers) associated with the process chambers 100, 302, 420, 432, 450 and the system 400. In operation, the system controller 444 enables data collection and feedback from the respective chambers and system controller 444 to optimize performance of the system 400.

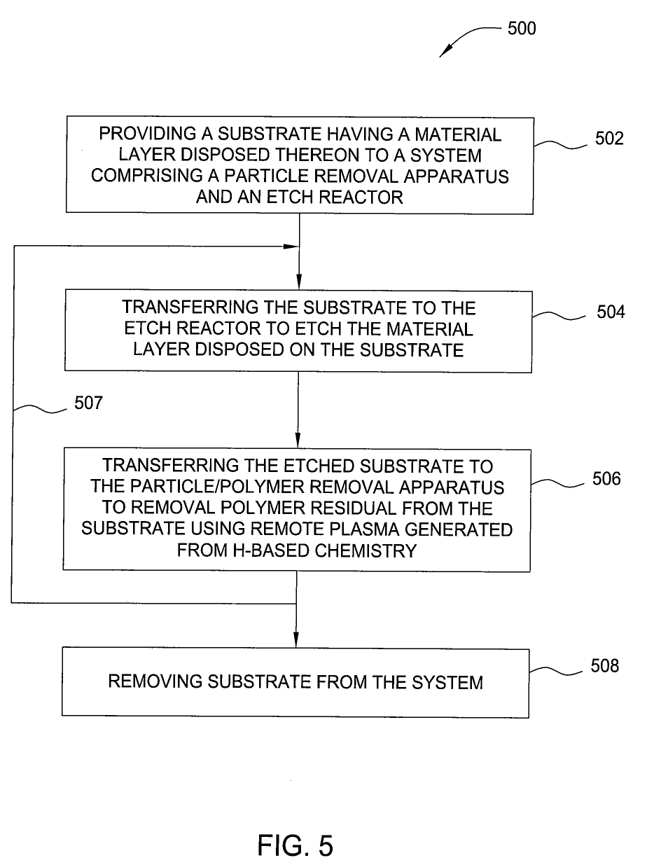

The system controller 444 generally includes a central processing unit (CPU) 438, a memory 440, and support circuit 442. The CPU 438 may be one of any form of a general purpose computer processor that can be used in an industrial setting. The support circuits 442 are conventionally coupled to the CPU 438 and may comprise cache, clock circuits, input/output subsystems, power supplies, and the like. The software routines, such as a method 500 for removing polymer residual described below with reference to FIG. 5, when executed by the CPU 438, transform the CPU 438 into a specific purpose computer (controller) 444. The software routines may also be stored and/or executed by a second controller (not shown) that is located remotely from the system 400.

FIG. 5 depicts a flow diagram of one embodiment of a method 500 for polymer removal process from a substrate in accordance with the present invention. The method 500 may be practiced on the system 400 or other suitable tool. It is contemplated that the method 500 may be performed in other suitable processing systems, including those from other manufacturers, or in facilities wherein the polymer removal chamber and etch reactor are on separate tools.

The method 500 begins at block 502 by providing a substrate 110 having a layer disposed thereon to be processed in the processing system 400. The substrate 110 may be any substrate or material surface upon which film processing is performed. In one embodiment, the substrate 110 may have a material layer or material layers formed thereon utilized to form a structure. The material layer that may be disposed on the substrate include a dielectric layer, such as a SiOC, SiO₂ or a SiCN, SiC or SiN layer. The substrate 110 may alternatively utilize a photoresist layer as an etch mask to promote the transfer of the features or structures to the substrate 110. In another embodiment, the substrate may have multiple layers, e.g., a film stack, utilized to form different patterns and/or features, such as dual damascene structure and the like. The substrate 110 may be a material such as crystalline silicon (e.g., Si<100> or Si<111>), silicon oxide, strained silicon, silicon germanium, doped or undoped polysilicon, doped or undoped silicon wafers and patterned or non-patterned wafers silicon on insulator (SOI), carbon doped silicon oxides, silicon nitride, doped silicon, germanium, gallium arsenide, glass, sapphire, metal layers disposed on silicon and the like. The substrate may have various dimensions, such as 200 mm or 300 mm diameter wafers, as well as, rectangular or square panels.

At block 504, the substrate 110 is transferred from one of the FOUPs 406A-B to the etch reactor 302 disposed in the system 400 to etch the material layer disposed on the substrate 110. Although the process described here is an etching process, it is contemplated that the substrate 110 may be processed under different applications, such as deposition, thermal anneal, implant and the like. In one embodiment, the material layer disposed on the substrate 110 is etched by a gas mixture containing carbon or fluorine carbon containing material, such as CF₄, C₄F₆, C₄F₈, CHF₃, C₂F₆, C₅F₈, CH₂F₂, CO, C₂ and the like. Alternatively, the substrate 110 may be etched by a halogen containing gas, such as carbon tetrafluoride (CF₄), C₄F₆, CHF₃, C₄F₈, CHF₃, C₂F₆, C₅F₈, CH₂F₂, SiF₄, SiCl₄, NF₃, and the like. Some carrier gas including N₂, Ar, He, CO, CO₂, O₂ may also be supplied to the etch reactor 302 during etching process. In the embodiment wherein the material layer disposed on the substrate 110 is a silicon carbide oxide layer (SiOC), a gas mixture including at least one of CF₄, C₄F₆, O₂ and Ar may be used to etch the material layer. In another exemplary embodiment wherein the material layer disposed on the substrate 110 is a silicon oxide layer (SiO₂), a gas mixture including at least one of C₄F₈, C₂F₆, CHF₃, CF₄, and C₄F₆ may be used to etch the material layer. In yet another embodiment wherein the material layer disposed on the substrate 110 is a silicon carbide (SiC) and/or a silicon carbide nitride layer (SiCN), the gas mixture including at least one of CH₂F₂, N₂ and Ar may be used to etch the material layer. In still another embodiment wherein the material layer disposed on the substrate 110 is a silicon nitride (SiN), the gas mixture including at least one of CH₂F₂, CHF₃, N₂ and Ar may be used to etch the material layer. The flow rate of the reacting gases, such as carbon, fluorine carbon containing material and a halogen containing gas, may be controlled at a flow rate between about 0 sccm and about 500 sccm, such as between about 0 sccm and about 200 sccm. The plasma power for the etch process may be maintained between about 200 Watts and about 3000 Watts, such as about 500 Watts and about 1500 Watts, and the bias power may be maintained between about 0 Watts and about 300 Watts. The process pressure may be controlled at between about 10 mTorr and about 100 mTorr, and the substrate temperature may be maintained at between about 0 degrees Celsius and about 200 degrees Celsius.

During etching process, the etched materials may combine with the components of the etchant chemistry, as well as with the components of the mask layers, if any, and by-products of the etch process, thereby forming polymer residues. The polymer residues and etch by-products may deposit on the substrate 110 including substrate bevel 132 and backside 136 of the substrate 172. Furthermore, portions of the photoresist layer utilized during the etching process may not be entirely consumed or removed, thereby remaining photoresist layer on the substrate front side 172 after the etching process. The photoresist layer remaining on the substrate front side 172 may result in organic or polymer contamination on the substrate front side 172 if not removed by the subsequent strip or ash process, thereby adversely affecting the performance of devices formed on the substrate 110.

At block 506, the processed (e.g., etched) substrate is transferred to the polymer removal processing chamber 100 to remove the polymer residuals, photoresist layer, if any, and etch by-products from the substrate 110 generated during block 504. The remote plasma source of the processing chamber 100 supplied active reactant, such as hydrogen and/or nitrogen containing gases, to the processing chamber 100 to assist removal of polymer residuals, photoresist layer and etch by-products from the substrate 110. As hydrogen species (H^{▪}, H*, H⁺), hydroxyl radical (—OH), nitrogen radical, and/or N—H radical are highly reactive radicals to polymers, upon supplied dissociated hydrogen, nitrogen or hydroxyl species into the processing chamber 100, the reactive species are actively reacted with the polymers, forming volatile compounds, readily pumping and outgassing the volatile compounds out of the processing chamber 100. The gas mixture may include an oxygen-containing gas, such as O₂, O₃, water vapor (H₂O), a hydrogen-containing gas, such as H₂, water vapor (H₂O), NH₃, nitrogen containing gas, such as N₂, N₂O, NH₃, NO₂, and the like, or an inert gas, such as a nitrogen gas (N₂), argon (Ar), helium (He), and the like.

In one embodiment, the active reactant supplied to the processing chamber 100 is generated from the remote plasma source from a gas mixture including at least one of hydrogen containing gas, such as H₂, water vapor (H₂O), oxygen (O₂) nitrogen (N₂), and NH₃. In the embodiment wherein the material layer being etched on the substrate is a silicon oxycarbide layer (SiOC), the active reactant supplied from the remote plasma source to the processing chamber includes hydrogen containing gas, such as H₂O or H₂. In another embodiment wherein the material layer being etched on the substrate is a silicon oxide layer (SiO₂), the active reactant supplied from the remote plasma source to the processing chamber includes nitrogen and/or hydrogen containing gas, such as NH₃ or H₂. As discussed above, dissociated hydrogen radical or hydroxyl radical (—OH), nitrogen radical, or N—H radical are highly active, accordingly, the materials for fabricating the remote plasma source 154, 206 are selected to be a hydrogen plasma resistant material. Examples of the materials include bare aluminum (Al), yttrium (Y) containing material, palladium (Pd) containing material, zirconium (Zr) containing material, hafnium (Hf) containing material, and niobium (Nb) containing material. More suitable examples of material for fabricating the remote plasma source are discussed above with referenced to FIGS. 1-2.

As discussed above, the substrate support assembly 126 may be vertically positioned and rotated, thereby allowing a photoresist material, when present on the front side 172 of the substrate, to may be removed along with polymer residues, e.g., the photoresist material is stripped from the substrate during the polymer removal process.

In the embodiment wherein the material etched on the substrate is a silicon oxycarbide film (SiOC), the gas mixture supplied through the remote plasma source to remove substrate bevel and backside polymer includes H₂, and H₂O. H₂ gas is supplied at a flow rate between about 500 sccm and about 5000 sccm, such as between about 1500 sccm and about 2500 sccm. H₂O is supplied at a flow rate between about 10 sccm and about 200 sccm, such as between about 15 sccm and about 40 sccm. The remote plasma source may provide a plasma power at between about 500 Watts and 15000 Watts, such as between about 4000 Watts and about 10000 Watts. An inert gas, such as Ar, He or N₂, may be supplied with the gas mixture to assist ignite plasma. The pressure controlled for processing is between about 0.5 Torr and about 4 Torr, such as about 2 Torr and about 2.5 Torr. Furthermore, the purge gas supplied from the purge gas source 104 is N₂ and may be provided at a flow rate between about 500 sccm and about 5000 sccm, such as about 1500 sccm and about 2500 sccm.

After substrate bevel and backside polymer has been removed, the substrate support assembly 126 may be elevated to the lower position readily to receive the reactive species from the remote plasma source to substrate front side 172 to remove photoresist layer. During photoresist removal process, the gas mixture supplied through the remote plasma source includes H₂ and H₂O. H₂ gas is supplied at a flow rate between about 500 sccm and about 5000 sccm, such as between about 1500 sccm and about 2500 sccm. H₂O is supplied at a flow rate between about 10 sccm and about 200 sccm, such as between about 15 sccm and about 40 sccm. The remote plasma source may provide a plasma power at between about 500 Watts and 15000 Watts, such as between about 4000 Watts and about 10000 Watts. An inert gas, such as Ar, He or N₂, may be supplied with the gas mixture to assist ignite plasma. The pressure controlled for processing is between about 0.5 Torr and about 4 Torr, such as about 1.5 Torr and about 3.0 Torr. During photoresist removal process, the purge gas from the purge gas source 104 may be eliminated.

In the embodiment wherein the material etched on the substrate is a silicon oxide film (SiO₂), the gas mixture supplied through the remote plasma source to remove substrate bevel and backside polymer includes N₂ and H₂. N₂ gas is supplied at a flow rate between about 200 sccm and about 2000 sccm, such as between about 700 sccm and about 1400 sccm. H₂ is supplied at a flow rate between about 50 sccm and about 500 sccm, such as between about 150 sccm and about 250 sccm. The remote plasma source may provide a plasma power at between about 500 Watts and 15000 Watts, such as between about 4000 Watts and about 10000 Watts. An inert gas, such as Ar, He or N₂, may be supplied with the gas mixture to assist ignite plasma. The pressure controlled for processing is between about 0.5 Torr and about 4 Torr, such as about 1 Torr and about 2 Torr. Furthermore, the purge gas supplied from the purge gas source 104 is N₂, gas having a flow rate between about 0 sccm and about 2000 sccm, such as about 0 sccm and about 200 sccm.

After substrate bevel and backside polymer has been removed, the substrate support assembly 126 may be elevated to the lower position readily to receive the reactive species from the remote plasma source to substrate front side to remove photoresist layer. During photoresist removal process, the gas mixture supplied through the remote plasma source includes O₂, and N₂. O₂ gas is supplied at a flow rate between about 500 sccm and about 8000 sccm, such as about 2000 sccm. N₂ is supplied at a flow rate between about 0 sccm and about 4000 sccm, such as about 500. The remote plasma source may provide a plasma power at between about 500 Watts and 15000 Watts, such as between about 4000 Watts and about 10000 Watts. An inert gas, such as Ar, He or N₂, may be supplied with the gas mixture to assist ignite plasma. The pressure controlled for processing is between about 0.5 Torr and about 4 Torr, such as about 1.5 Torr and about 3 Torr. During photoresist removal process, the purge gas from the purge gas source 104 may be eliminated.

Optionally, the substrate 110 may be returned to any one of the processing chamber 100, 302, 420, 432 of the system 400 for additional processing prior to removing from the vacuum environment, as indicated in loop 507.

At block 508, after completion of the process performed on the substrate 110, the substrate 110 is removed from the system 400. It is noted that the substrate processing and polymer removal process may be repeatedly performed in the system as needed.

Thus, the present invention provides a method and apparatus for removing polymer residues and photoresist layer, if present, on a substrate. The method and apparatus advantageously removes polymer residuals adhered on substrate backside and substrate bevel. Removal of polymers residual efficiently not only eliminates contamination on a substrate but also prevents transfer of contamination into other processing chambers during subsequent processing, thereby improving product yield and enhancing productivity and process throughput.

While the foregoing is directed to embodiments of the present invention, other and further embodiments of the invention may be devised without departing from the basic scope thereof, and the scope thereof is determined by the claims that follow.

What is claimed is:

1. An apparatus utilized to remove polymer from a substrate, comprising:
a processing chamber having a chamber wall and a chamber lid defining a process volume;
a substrate support assembly disposed in the processing chamber; and
a remote plasma source coupled to the processing chamber through an outlet port formed through the processing chamber, the outlet port having an opening pointing toward an periphery region of a substrate disposed on the substrate support assembly, wherein a surface exposed to plasma within the remote plasma source is fabricated from a material resistant to reductive deterioration by hydrogen species.

2. The apparatus of claim 1, wherein the hydrogen resistant material is selected from a group consisting of bare aluminum Al, yttrium (Y) containing material, palladium (Pd) containing material, zirconium (Zr) containing material, hafnium (HD containing material, and niobium (Nb) containing material.

3. The apparatus of claim 1, further comprises:
a step formed on periphery region of the substrate support assembly, the step sized to allow the substrate to extend thereover.

4. The apparatus of claim 3, wherein the outlet port is positioned in the sidewall and directs gases from the remote plasma source in a substantially horizontal direction, wherein an elevation of the substrate support assembly is adjustable relative to the outlet port, wherein the substrate support assembly rotates within the process volume.

5. The apparatus of claim 4, wherein the gas supplied from the remote plasma source is a hydrogen containing gas.

6. The apparatus of claim 5, wherein the hydrogen containing gas includes at least one of H₂, water vapor (H₂O) or NH₃.

7. The apparatus of claim 1, wherein the remote plasma source includes a toroidal processing chamber.

8. The apparatus of claim 7, wherein the toroidal chamber is fabricated from or coated with the hydrogen resistant material selected from a group consisting of bare aluminum Al, yttrium (Y) containing material, palladium (Pd) containing material, zirconium (Zr) containing material, hafnium (Hf) containing material, and niobium (Nb) containing material.

9. The apparatus of claim 8, wherein the toroidal processing chamber is fabricated from a plastic coated with the hydrogen resistant material.

10. A substrate processing system, comprising:
a vacuum transfer chamber having a robot,
an etch reactor coupled to the transfer chamber and configured to etch a dielectric material disposed on the substrate, wherein the dielectric material is selected from at least one of silicon oxide and silicon oxycarbide;
a polymer removal chamber coupled to the transfer chamber, the robot configured to transfer a substrate between polymer removal chamber and the etch reactor, the polymer removal chamber having a remote plasma source providing reactive species to an interior of the polymer removal chamber, wherein a surface exposed to plasma within the remote plasma source is fabricated from a material resistant to reductive deterioration by hydrogen species.

11. The system of claim 10, wherein the material resistant to reductive deterioration is selected from a group consisting of bare aluminum (Al) material, yttrium (Y) containing material, palladium (Pd) containing material, zirconium (Zr) containing material, hafnium (Hf) containing material, and niobium (Nb) containing material.

12. The system of claim 11, wherein an interior surface of the remote plasma source is coated the material resistant to reductive deterioration is selected from a group consisting of bare aluminum (Al) material, yttrium (Y) containing material, palladium (Pd) containing material, zirconium (Zr) containing material, hafnium (Hf) containing material, and niobium (Nb) containing material.

13. The system of claim 12, wherein the remote plasma source is fabricated from a plastic coated with the material resistant to reductive deterioration.

14. The system of claim 10, wherein the etch reactor further comprises:
a source of carbon fluorine gas.

15. The system of claim 14, wherein the polymer removal chamber further comprises:
a source of H₂O gas coupled to the remote plasma source.

16. The system of claim 10, wherein the etch reactor further comprises:
a source of a halogen containing gas.

17. The system of claim 16, wherein the polymer removal chamber further comprises:
a source of NH₃ gas coupled to the remote plasma source.

18. A method for removing polymer from a substrate, comprising:
etching a material layer disposed on a substrate in an etch reactor;
transferring the etched substrate to polymer removal chamber;
supplying an inert gas to a front side of the substrate through a center region disposed in the polymer removal chamber;
supplying a hydrogen containing gas through a remote plasma source coupled to the polymer removal chamber to an periphery region of the substrate, wherein a surface exposed to plasma within the remote plasma source is fabricated from a material resistant to reductive deterioration by hydrogen species.

19. The method of claim 18, wherein the material resistant to reductive deterioration is selected from a group consisting of bare aluminum (Al), yttrium (Y) containing material, palladium (Pd) containing material, zirconium (Zr) containing material, hafnium (Hf) containing material, and niobium (Nb) containing material.

20. The method of claim 18, wherein the remote plasma source further comprises plastic coated with the material resistant to reductive deterioration.

21. The method of claim 18, wherein etching the material layer further comprises:
etching the material layer by a carbon fluorine gas, wherein the material layer is a silicon oxycarbide layer.

22. The method of claim 21, wherein hydrogen containing gas is H₂O.

23. The method of claim 18, wherein etching the material layer further comprises:
etching the material layer by a halogen containing gas, wherein the material layer is a silicon oxide layer.

24. The method of claim 23, wherein the hydrogen containing gas is NH₃.

25. The method of claim 18 further comprising:
removing a photoresist layer from the front side of the substrate.
